(19) United States
(12) Patent Application Publication
(10) Pub. No.: US 2012/0178858 A1
(43) Pub. Date: Jul. 12, 2012

(54) Isosorbide-Plasticized Starch And Uses Thereof

(76) Inventors: Andrew Julian Wnuk, Wyoming, OH (US); Shrish Yashwant Rane, Madeira, OH (US); James Terry Knapmeyer, Cincinnati, OH (US)

(21) Appl. No.: 12/987,294

(22) Filed: Jan. 10, 2011

(51) Int. Cl. C08K 5/04; C04B 16/04

(52) U.S. Cl. 524/47; 106/501.1

(57) ABSTRACT

Starch plasticized, wholly or in part, with isosorbide, isomannide, isoidide, or a mixture thereof is disclosed. Blends of the plasticized starch and a synthetic polymer, like a polyolefin, also are disclosed.

### FIELD OF THE INVENTION

The present invention relates to a thermoplastic starch wherein the starch is plasticized, wholly or in part, with isosorbide. The present invention also relates to compositions comprising a synthetic polymer blended with the isosorbide-plasticized starch.

### BACKGROUND OF THE INVENTION

An increasing demand for plastics made from non-renewable resources has negative environmental consequences. Researchers therefore are seeking alternative resources based on renewable materials, such as starch.

Starch is a plentiful, inexpensive, and renewable material found in a large variety of plant sources, such as grains, tubers, fruits, and the like. Starch can be isolated as a granular powder. In many cases, starch is discarded as an unwanted byproduct of food processing. Because starch is both renewably sourced and biodegradable, investigators have attempted to incorporate starch into a variety of materials in order to improve the environmental profile of the material. For example, starch has been incorporated into compositions to perform various functions, including as a filler, binder, or as a constituent within thermoplastic polymer blends.

A blend of starch with a synthetic polymer, such as polyethylene or polypropylene, has been of interest because starch is an abundant and inexpensive filler material, can lower raw material costs, and can impart partial biodegradability to the resulting blend. However, starch often can have a negative impact on the physical properties of the polymer mixture compared to the pure synthetic polymer. Furthermore, when starch is mixed with synthetic polymers or copolymers, the starch domains are enveloped by the non-biodegradable synthetic polymers, and consequently starch biodegradability is significantly reduced.

Investigators have attempted to process natural starch for such functions on standard equipment using technology known in the plastic industry. Many investigators also have attempted to use starch as a thermoplastic material, either alone or as a component within thermoplastic blends. However, native starch does not behave as a thermoplastic material by itself, but must be heated in the presence of a plasticizer. Because natural starch has a granular structure, it needs to be “destructurized” or “gelatinized” and/or otherwise modified, for example, by derivativization into starch ethers or starch esters, before it can be melt-processed, like a thermoplastic material. It is known that natural starch can be treated at an elevated temperature and pressure with the addition of defined amounts of water to form a melt. Such a melt is referred to as destructurized starch. Starch is said to be “destructurized” because it is no longer a solid granular particulate as in its native state. Moreover, it is “destructurized” because the dissolution or melting of starch in the presence of water or other plasticizer generally is an irreversible process. The destructuring process swells and disrupts the granular morphology of native starch, thus lowering its viscosity. This allows good melt mixing with the plasticizer in the blend. Further, the use of suitable compatibilizers can help further lock in the dispersed thermoplastic starch domains, which decreases the rate of retrogradation or recrystallization of the starch component

The degree to which starch is “destructured” or “gelatinzed” can be determined analytically. Such a method is disclosed in “Determination of the Degree of Gelatinization and Retrogradation of Starch,” authored by Keiji Kainuma, and published in Methods in Carbohydrate Chemistry, Volume X, John Wiley & Sons. Inc., pp 137-141 (1994), incorporated herein by reference.

Typically, a starch plasticizer is a liquid, at least at an elevated processing temperature, and is chemically compatible with starch, which is highly polar and hydrophilic due to the hydroxyl groups on about half of the carbon atoms. Plasticizers for starch can be either relatively volatile liquids, such as water, low volatility liquids, such as glycerin, or aqueous solutions of substances, such as glucose and mannitol. Unlike dry, granular starch, the resulting thermoplastic starch (TPS) is capable of flow, and standard polymer blending protocols therefore can be used to process the TPS.

Thermoplastic starch compositions are well known and disclosed in several patents, for example: U.S. Pat. No. 5,280,055; U.S. Pat. No. 5,314,934; U.S. Pat. No. 5,362,777; U.S. Pat. No. 5,844,023; U.S. Pat. No. 6,214,907; U.S. Pat. No. 6,242,102; U.S. Pat. No. 6,096,809; U.S. Pat. No. 6,218,321; U.S. Pat. No. 6,235,815; U.S. Pat. No. 6,235,816; and U.S. Pat. No. 6,231,970, each incorporated herein by reference.

Because starch is an inexpensive, renewable, and biodegradable resource, blends of synthetic polymers and TPS represent a route towards environmentally viable plastics. However, thermoplastic starches have been limited in the marketplace by adverse effects demonstrated by the TPS itself and polymer blends containing a TPS. Synthetic polymers can be sensitive to TPS loading and mechanical properties diminish with the addition of a TPS. It is therefore key to provide new polymer blends, that despite TPS loading, maintain or even improve the mechanical properties of the end products when compared to pure (virgin) synthetic polymers.

### SUMMARY OF THE INVENTION

The present invention is directed to an isosorbide-plasticized TPS. The TPS can be plasticized solely with isosorbide, or can be plasticized with isosorbide and at least one additional plasticizing agent, such as water, glycerol, sorbitol, or mixtures thereof.

Therefore, one aspect of the invention is to provide a TPS, wherein starch or a starch derivative is plasticized, wholly or in part, with isosorbide. In one embodiment, the TPS is plasticized with isosorbide and sorbitol.

Another aspect of the present invention is to provide an isosorbide-plasticized TPS having improved properties compared to prior TPSs and that is capable of imparting improved properties to a synthetic polymer, for example, a TPS that:

(a) lowers the stiffness of a TPS/synthetic polymer blend and increases elongation of the blend to break at very low addition levels;

(b) does not crystallize and separate from a TPS/synthetic polymer blend, like prior plasticizers, such as sorbitol;

(c) does not migrate from a TPS/synthetic polymer blend, like prior plasticizers, such as glycerol;

(d) reduces thermal discoloration (browning) of TPS/synthetic polymer blends due to a high thermal stability; and

(e) can be incorporated into TPS/synthetic polymer blends used for injection molding, film/sheet extrusion, blow molding, and fiber melt spinning for woven and nonwoven fabric applications.

Yet another aspect of the present invention is to provide a polymer blend comprising a synthetic polymer, such as a polyolefin, polyester, or polyamide, and an isosorbide-plasticized TPS. The synthetic polymer may be derived from fossil fuel precursors, such as petroleum, natural gas, or coal. The synthetic polymer also may be derived from biological precursors, such as agricultural products, forest products, or byproducts of the meat and dairy processing industries. The synthetic polymer may be biodegradable or non-biodegradable.

These and other aspects of the present invention will become apparent from the following detailed description of the preferred embodiments.

### BRIEF DESCRIPTION OF THE DRAWINGS

FIG. 1 is a schematic view of a sample preparation technique for typical STEM micrograph of a TPS structure.

FIG. 2 is a STEM image of starch particles incorporated in a continuous matrix.

FIG. 3A is a STEM image of a blend containing starch, about 20% PP, 10% glycerol, and 23% sorbitol, compounded at 25 lb/hr.

FIG. 3B is another STEM image of a blend containing starch, about 20% PP, 10% glycerol, and 23% sorbitol, compounded at 25 lb/hr.

FIG. 3C is a STEM image of a blend containing starch, about 21.9% PP, 17.5% glycerol, and 9.5% isosorbide, compounded at 20 lb/hr.

FIG. 3D is another STEM image of a blend containing starch, about 21.9% PP, 17.5% glycerol, and 9.5% isosorbide, compounded at 20 lb/hr.

### DETAILED DESCRIPTION OF THE PREFERRED EMBODIMENTS

The term “thermoplastic” is understood in the art and used to denote compounds and compositions that generally are capable of repeated softening when appropriately heated and hardening when subsequently cooled. “Thermoplastic” materials generally are in a solid or form stable state below the melting point or softening range, and generally are in a plastic or flowable state above the melting point or softening range. The term “solid” means that the material is sufficiently hardened or nonflowable such that it substantially maintains its shape without external support, and can have a degree of resilience, bendability, or deformability.

As used herein, “thermoplastic starch” or “TPS” means native starch or a starch derivative that has been rendered thermoplastic by treatment with one or more plasticizers.

Starch and starch derivatives have been destructurized and plasticized using a wide variety of compounds, such as water, glycerol, and sorbitol. Such TPSs exhibit disadvantages that limit practical applications, even though the biogradability of a TPS is a highly desirable property. The present invention improves upon prior TPSs by utilizing isosorbide as a plasticizing agent for starch or a starch derivative.

A substantial problem exhibited by prior compositions based on blends of (a) a polyolefin with (b) starch or a starch derivative (e.g., hydroxyethyl starch or hydroxypropyl starch) plasticized with glycerol and/or sorbitol is stability of the composition over time. Such blends are very heterogeneous when examined using scanning transmission electron microscopy (STEM) and their properties change over time due to crystallization of the sorbitol or separation of glycerol from the blend. Isosorbide has been found to be an unexpectedly effective destructurizing agent for starch and starch derivatives, and a plasticizer/modifier for TPS/synthetic polymer blends. For example, replacement of all or a portion of the sorbitol with isosorbide results in a TPS/polymer blend in which the matrix surrounding the starch globules appears much more homogeneous. Moreover, isosorbide does not separate from the TPS or TPS/polymer blend, and isosorbide retards the post crystallization of sorbitol in TPS/polymer blends.

In accordance with one embodiment of the present invention, a starch or starch derivative is plasticized with isosorbide using methods well known in the art. The starch or starch derivative is plasticized using about 5% to about 45% isosorbide, by total weight of the TPS. The specific amount of isosorbide is selected to provide the desired properties of the TPS or a polymer blend containing the TPS.

Isosorbide is a low melting (melting point about 65° C.), water soluble, bio-sourced compound derived from sorbitol by a double dehydration. Isosorbide is one of three isomeric forms of 1,4-3,6 dianhydrohexitol. Dianhydrohexitols are by-products of the starch industry obtained by dehydration of D-hexitols, which are made by a simple reduction of hexose sugars. These chiral biomass-derived products exist as three main isomers, i.e., isosorbide, isomannide, and isoidide, derived from D-glucose, D-mannose, and L-fructose, respectively, depending on the configuration of the two hydroxyl groups. Isosorbide, which is produced from glucose via sorbitol, is the most widely available 1,4-3,6 dianhydrohexitol.

Isosorbide, isomannide, and isoidide are thermally stable compounds capable of withstanding the process conditions required to prepare a TPS and the extrusion conditions used to blend a TPS with a synthetic polymer. Isosorbide, isomannide, isoidide, and mixtures thereof, therefore can be used in the present invention. Accordingly, as used herein, the term “isosorbide” refers to isosorbide, isomannide, isoidide, and mixtures thereof.

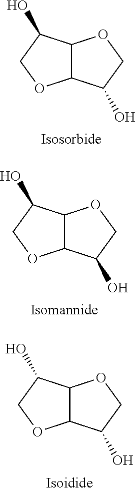

Another aspect of the present invention is to provide TPS/polymer blends that includes a fraction of the plasticizer content compared to present TPS/polymer blends.

It is an additional aspect of the invention to provide TPS/polymer blends that have improved physical properties, such as increased thermal stability, increased modulus of elasticity, compressive strength, and elongation, compared to previous TPS/polymer blends. It is yet an additional aspect that such TPS/polymer blends yield articles that are readily biodegradable.

Starch is a polysaccharide that consists essentially of a blend of amylase and amylopectin. As used herein, the term “starch” refers to any starch of natural origin whether processed, chemically modified or treated, including, for example, wheat starch, corn starch, potato starch, sweet potato, and rice starch. Starch can also be derived from other plant sources such as cassava, tapioca, and pea.

The term “starch” includes modified starches, either chemically or enzymatically, such as chemically-treated and crosslinked starches, and starches in which the hydroxyl groups have been substituted with organic acids to provide esters, or with organic alcohols to provide ethers, with degrees of substitution in the range 0-3. A modified starch is contrasted with a native starch, which is a starch that has not been modified, chemically or otherwise, in any way. The term starch also includes extended starches, such as those extended with proteins, for example, with soya protein. As used herein, the term “starch” therefore refers to starch and starch derivatives. As such, the term encompasses, but is not limited to, starch, hydroxyethyl starch, hydroxypropyl starch, carboxymethylated starch, starch phosphate, starch acetate, a cationic starch (e.g. 2-hydroxy-3-trimethyl(ammoniumpropyl) starch chloride), starch modified by acid, base, or enzyme hydrolysis, starch modified by oxidation, and mixtures thereof.

In a second embodiment of the present invention, isosorbide and a second plasticizing agent are used to plasticize the starch or starch derivative. In this embodiment, the TPS contains a total plasticizer content of about 5% to about 50%, by weight, plasticizer, and the isosorbide is about 5% to about 90%, by weight, of the total plasticizer content.

In this embodiment of the present invention, the second plasticizing agent can be one or more of glycerol, ethylene glycol propylene glycol, ethylene diglycol propylene diglycol, ethylene triglycol, propylene triglycol, polyethylene glycol, polypropylene glycol, 1,2-propanediol, 1,3-propanediol, 1,2-butanediol, 1,3-butanediol, 1,4-butanediol, 1,5-pentanediol, 1,6-hexanediol, 1,5-hexanediol, 1,2,6-hexanetriol, 1,3,5-hexanetriol, neopentyl glycol, trimethylolpropane, pentaerythritol, sorbitol, tridecyl adipate, isodecyl benzoate, tributyl citrate, tributyl phosphate, dimethyl sebacate, urea, glycerol ethoxylate, pentaerythritol ethoxylate, sorbitol acetate, pentaerythritol acetate, ethylenebisformamide, a low molecular weight sugar, sorbitol diacetate, sorbitol monoethoxylate, sorbitol diethoxylate, sorbitol hexaethoxylate, sorbitol dipropoxylate, aminosorbitol, trihydroxymethylaminomethane, glucose/PEG, a reaction product of ethylene oxide with glucose, trimethylolpropane monoethoxylate, mannitol monoacetate, mannitol monoethoxylate, butyl glucoside, glucose monoethoxylate, α-methyl glucoside, the sodium salt of carboxymethylsorbitol, sodium lactate, polyglycerol monoethoxylate, erythriol, arabitol, adonitol, xylitol, mannitol, iditol, allitol, malitol, polyhydric alcohols generally, esters of glycerin, formaide, N-methylformamide, DMSO, mono- and diglycerides, alkylamides, polyols, polyvinyl alcohol having 3 to 20 repeating units, polyglycerol having 2 to 10 repeating units, derivatives of the foregoing, and mixtures thereof.

Prior plasticizers can exhibit substantial drawbacks when used in a TPS. For example, sorbitol and glycerol are commonly used as plasticizers and process aids for starch and starch derivatives. However, glycerol tends to migrate out of a TPS under the high shear and temperatures encountered, for example, during the spun bond process to make nonwovens. Further, sorbitol has been shown to degrade via char forming reactions (e.g., Maillard browning reaction or caramelization), which is common for sugars. Because isosorbide is a solid melting at 61-64° C., is stable at 270° C., soluble in water, alcohols, dioxane, and ketones, and generally recognized as safe for human exposure, isosorbide is an attractive, less mobile replacement for glycerol and/or a more thermally stable replacement for sorbitol, while being consumer and environmentally acceptable.

Isosorbide can be compounded into a starch or starch derivatives using a twin screw extruder. The isosorbide can be pumped into the extruder in molten form, as an aqueous solution containing up to about 80% isosorbide, as a glycerol solution, or a dry powder. The isosorbide also can be precompounded with other components of the TPS formulation and fed into the extruder.

In a third embodiment of the present invention, a TPS plasticized wholly or in part with isosorbide is blended with a synthetic polymer to lower cost relative to that of the pure synthetic polymer, to substitute a renewable content for a non-renewable resource, to impart desired physical properties to the synthetic polymer, and/or to confer a degree of biodegradability to the synthetic polymer. A mixture of a TPS and a synthetic polymer, i.e., TPS/synthetic polymer blend, typically is prepared via an extrusion process and is in the form of a pellet, sheet, or fiber, for example. The isosorbide-containing TPS is blended with a synthetic polymer, with the synthetic polymer present in an amount of about 1% to about 90%, and preferably about 10% to about 80%, by weight of the TPS/polymer blend.

The synthetic polymer can be a single polymer or a mixture of polymers, and includes any substantially non-polar. i.e. water-insoluble or hydrophobic, synthetic thermoplastic or thermoset polymer. Examples of substantially water-insoluble thermoplastic homopolymer resins are polyolefins, such as polyethylene (PE), polypropylene (PP), and polyisobutylene; vinyl polymers, such as poly(vinyl chloride) (PVC), poly(vinyl acetate) (PVA), poly(vinyl carbazoles); polystyrenes; substantially water-insoluble polyacrylates or polymethacrylates, such as poly(acrylic acid)esters, poly(methacrylic acid)esters; polyacetals (POM); polyamides, such as nylon 6, nylon-6,6, aliphatic and aromatic polyamides; polyesters, such as poly(ethylene terephthalate) (PET), poly(butylene terephthalate) (PBT); polyarylethers; polyurethanes, polycarbonates, polyimides, and high molar mass, substantially water-insoluble or crystallizable poly(alkylene oxides), such as poly(ethylene oxide), poly(propylene oxide).

Additional synthetic polymers are polyesters and polylactides that are considered biodegradable in short time periods. Examples of such water-insoluble materials are polylactones, such as poly(epsilon-caprolactone), and copolymers of epsilon-caprolactone with isocyanates; bacterial poly(hydroxyalkanoates), such as poly(hydroxybutyrate-3-hydroxyvalerate); and polylactides, such as poly(lactic acid), poly(glycolic acid) and copolymers comprising the repetitive units of both.

Further included are substantially water-insoluble thermoplastic α-olefin copolymers. Examples of such copolymers are alkylene/vinyl ester-copolymers, such as ethylene/vinyl acetate-copolymers (EVA), ethylene/vinyl alcohol-copolymers (EVAL); alkylene/acrylate or methacrylate-copolymers preferably ethylene/acrylic acid-copolymers (EAA), ethylene/ethyl acrylate-copolymers (EEA), ethylene/methyl acrylate-copolymers (EMA), or alkylene/maleic anhydride copolymers, such as ethylene/maleic anhydride or propylene/maleic anhydride copolymers.

Further included are styrenic copolymers, which comprise random, block, graft, or core-shell architectures. Examples of such styrenic copolymers are α-olefin/styrene-copolymers, preferably hydrogenated and non-hydrogenated styrene/ethylene-butylene/styrene copolymers (SEBS), styrene/ethylene-butadiene copolymers (SEB); styrene acrylonitrile copolymers (SAN); and acrylonitrile/butadiene/styrene copolymers (ABS).

Further included are other copolymers, such as acrylic acid ester/acrylonitrile copolymers, acrylamide/acrylonitrile copolymers, block copolymers of amide-esters, block copolymers of urethane-ethers, and block copolymers of urethane-esters. Further included are uncrosslinked or partially crosslinked prepolymers or precursors of thermoset resins, such as epoxy resins, polyurethanes, and alkyd resins.

The following nonlimiting examples demonstrate the advantages and improvements provided by a present isosorbide-plasticized TPS and synthetic blends containing the isosorbide-plasticized TPS.

### Example 1

This example illustrates the ability of molten isosorbide alone to substantially destructure ethoxylated starch.

Isosorbide (4.0 kg) (Archer Daniels Midland, Technical grade) was melted in a metal container in a 90° C. oven. Concurrently, a Baker-Perkins twin screw extruder (Model CT-25) equipped with 25 mm co-rotating screws having a 40:1 length-to-diameter ratio, separate liquid and powder feeding systems, and a strand die was preheated to achieve the temperatures indicated in the table below. The screw was configured to have high shear elements to assist in efficient destructering of starch in the presence of the plasticizer. Screw rotation was maintained at about 450 revolutions per minute (rpm) providing an extruder output rate of about 20 to about 40 pounds per hour depending upon the actual composition being run.

The liquid feeder reservoir was preheated to 80° C. and filled with molten isosorbide. The strand die was positioned above a silicone-coated conveyor belt, the length and speed of which was selected to sufficiently cool and solidify the molten extruded strands prior to the strands entering a pelletizer, where they were chopped into small pellets.

| | Zone | Zone | Zone | Zone | Zone | Zone | Zone | Zone | |
|---|---|---|---|---|---|---|---|---|---|
| | 2 | 3 | 4 | 5 | 6 | 7 | 8 | 9 | Die |
| Setting | 60 | 100 | 150 | 155 | 160 | 165 | 165 | 155 | 145 |
| (° C.) | | | | | | | | | |
| Actual | 61 | 94 | 112 | 137 | 157 | 170 | 169 | 157 | 148 |
| (° C.) | | | | | | | | | |

Ethoxylated starch (Gradename Coatmaster K-96) from Grain Processing Corp. was placed in the powder feeder. The powder feeder and the liquid feeder were calibrated to dispense the starch and molten isosorbide such that starch/isosorbide weight ratios of 50/50, 60/40, 65/35, and 70/30 were evaluated in separate experiments.

The four experiments provided the following information:

a) At a 50/50 starch/isosorbide weight ratio, and at the temperatures indicated above, the composition was overplasticized such that the strands had very little melt strength and could not be collected and pelletized.

b) At a 60/40 starch/isosorbide weight ratio, the strands were extruded with adequate melt strength to be collected and pelletized. The resulting pellets were very clear, with a slight amber color. When these pellets were analyzed for % destructurization of the starch component, it was found that the starch was about 100% destructurized.

c) At a 65/35 starch/isosorbide weight ratio, the strands were extruded with adequate melt strength to be collected and pelletized. The resulting pellets were very clear, with a slight amber color. When these pellets were analyzed for % destructurization of the starch component, it was found that the destucturization was about 95 to about 98%.

d) At a 70/30 starch/isosorbide weight ratio, the strands were extruded with adequate melt strength to be collected and pelletized. The resulting pellets were brownish in color. When these pellets were analyzed for % destructurization of the starch component, it was found that the destructurization was about 100%.

### Example 2

This example illustrates the ability of a concentrated isosorbide/water solution (70/30 w/w) to substantially destructure ethoxylated starch.

A 70% w/w solution of isosorbide in water was prepared using 2019.5 grams of isosorbide and 865.5 g of distilled water. The solution was placed in the liquid feeder system described in Example 1, then heated to about 80° C. The powder and liquid feeding systems were adjusted to provide a 60/40 w/w ratio of ethoxylated starch/70% isosorbide solution. The final weight ratio of this composition therefore was about 60% starch/28% isosorbide/12% water. The strands were extruded with adequate melt strength to be collected and pelletized. The resulting pellets were very clear, with an amber color. When these pellets were analyzed for % destructurization of the starch component, it was found that the destructurization ranged from about 98 to about 99%.

Comparative Example 3 and Examples 4 and 5 illustrate the effect of substituting low levels of isosorbide for sorbitol in a thermoplastic starch composition.

### Comparative Example 3

### Thermoplastic Starch Blend Free of Isosorbide

In a Henschel laboratory mixer (Model FML40), 1455 g sorbitol (Archer Daniels Midland), 2870 g ethoxylated starch (Grain Processing Corp.), and 25 g magnesium stearate (Spectrum Chemical Mfg. Corp.) were combined and mixed at 1000 rpm for 4 minutes.

Concurrently, a Baker-Perkins twin screw extruder (Model CT-25) equipped with 25 mm co-rotating screws, separate liquid and powder feeding systems, and a strand die was preheated to achieve the temperatures indicated in the table below. The starch mixture described above was added to the powder feeder.

| | Zone | Zone | Zone | Zone | Zone | Zone | Zone | Zone | |
|---|---|---|---|---|---|---|---|---|---|
| | 2 | 3 | 4 | 5 | 6 | 7 | 8 | 9 | Die |
| Setting | 40 | 125 | 130 | 135 | 140 | 140 | 140 | 130 | 130 |
| (° C.) | | | | | | | | | |
| Actual | 50 | 110 | 124 | 134 | 137 | 139 | 138 | 130 | 126 |
| (° C.) | | | | | | | | | |

The liquid feeder reservoir was preheated to 80° C. and filled with refined glycerol. The strand die was positioned above a silicone-coated conveyor belt, the length and speed of which was selected to sufficiently cool and solidify the molten extruded strands prior to the strands entering a pelletizer where they were chopped into small pellets.

The powder feeder and the liquid feeder were calibrated to dispense the starch mixture and glycerol such that a composition comprising about 13% glycerol, 29.1% sorbitol, 57.4% starch, and 0.5% magnesium stearate (weight %) was extruded from the strand die onto the conveyor belt, where it was cooled and solidified before being pelletized and collected in a bucket.

A portion of the pellets of Comparative Example 3 were compression molded into a flat sheet about 0.020″ thick on a heated press. ASTM Type V dogbone shaped tensile test specimens were die cut from the sheet and conditioned at 73° F. and 50% relative humidity (RH) for 24 hours before testing. The test specimens then were subjected to tensile tests at 73° F. and 50% RH on an Instron Model 1122 at a cross head speed of about 2.0 inches/minute. The test results are summarized in the table below.

### Example 4

### Thermoplastic Starch Blend Containing 5% Isosorbide

The procedure of Comparative Example 3 was repeated with the following exceptions. In a Henschel laboratory mixer (Model FML40), 1205.5 g sorbitol (Archer Daniels Midland), 250.0 g isosorbide (Archer Daniels Midland), 2870 g ethoxylated starch (Grain Processing Corp.), and 25 g magnesium stearate were combined and mixed at 1000 rpm for 4 minutes.

The liquid feeder reservoir was preheated to 80° C. and filled with refined glycerol. The strand die was positioned above a silicone-coated conveyor belt, the length and speed of which was selected to sufficiently cool and solidify the molten extruded strands prior to the strands entering a pelletizer, where they were chopped into small pellets.

The powder feeder and the liquid feeder were calibrated to dispense the starch mixture and glycerol such that a composition comprising about 13% glycerol, 24.1% sorbitol, 5% isosorbide, 57.4% starch, and 0.5% magnesium stearate (weight %) was extruded from the strand die onto the conveyor belt, where it was cooled and solidified before being pelletized and collected in a bucket.

In this example, about 5 wt. % of the sorbitol contained in Comparative Example 3 was substituted by about 5 wt % isosorbide.

A portion of the pellets of Example 4 were compression molded into a flat sheet about 0.020″ thick on a heated press. ASTM Type V dogbone shaped tensile test specimens were die cut from the sheet and conditioned at 73° F. and 50% relative humidity (RH) for 24 hours before testing. The test specimens then were subjected to tensile tests at 73° F. and 50% RH on an Instron Model 1122 at a cross head speed of about 2.0 inches/minute. The test results were summarized in the table below.

| | | | | | | Strain |
|---|---|---|---|---|---|---|
| | % | | Stress at | Strain at | Stress at | at |
| | isosorbide | Modulus | yield | yield | Break | Break |
| | in blend | (MPa) | (MPa) | (%) | (MPa) | (%) |
| Comparative | 0 | 11 | 1.4 | 139 | 0.7 | 219 |
| Example 3 | | | | | | |
| Example 4 | 5 | 3.5 | 0.8 | 233 | 0.1 | 536 |
| % change | +5% | −68.2% | −42.8% | +67.6% | −85.7% | 145% |

Surprisingly, it was found that substituting only about 5 wt. % sorbitol with about 5 wt. % isosorbide significantly decreased the modulus, stress at yield, and stress at break, while significantly increasing the strain at yield and strain at break.

### Example 5

### Thermoplastic Starch Blend Containing 15% Isosorbide

The procedure of Comparative Example 3 was followed with the following exceptions. In a Henschel laboratory mixer (Model FML40), 705 g sorbitol (Archer Daniels Midland), 750 g isosorbide (Archer Daniels Midland), 2870 g ethoxylated starch (Grain Processing Corp.), and 25 g magnesium stearate were combined and mixed at 1000 rpm for 4 minutes.

The liquid feeder reservoir was preheated to 80° C. and filled with refined glycerol. The strand die was positioned above a silicone-coated conveyor belt, the length and speed of which was selected to sufficiently cool and solidify the molten extruded strands by the time they reach the end of the conveyor.

The powder feeder and the liquid feeder were calibrated to dispense the starch mixture and glycerol such that a composition comprising about 13% glycerol, 14.1% sorbitol, 15% isosorbide, 57.4% starch, and 0.5% magnesium stearate (all in weight %) was extruded from the strand die onto the conveyor belt, where it was cooled and solidified. The pellets produced in this example were too soft to be pelletized mechanically and collected in a bucket. The cooled strands therefore were manually cut in to short segments and stored for testing.

A portion of the cut strand segments of Example 5 were compression molded into a flat sheet about 0.020 inches thick on a heated press. ASTM Type V dogbone shaped tensile test specimens were die cut from the sheet and conditioned at 73° F. and 50% RH for 24 hours before testing. However, when the test specimens were placed in the grips of the Instron tensile tester, they were too soft to withstand the pressure imparted by the grips. The deformation of the test specimens in the grip areas prevented reliable data from being collected.

Example 5 therefore further exemplifies the unexpectedly significant impact of isosorbide on the stiffness and mechanical properties of a TPS.

Example 4 demonstrates that isosorbide has an unexpected utility as a modifier for thermoplastic starch formulations. The results in the above table show a unexpected softening and ductility (pliability) in TPS compositions containing a low amount of isosorbide. As shown, replacing just 5% of sorbitol with 5% of isosorbide increases ductility (strain at break) by almost 150% over that of the control TPS. As further shown in the above table, a small 5% level of isosorbide in these TPS formulations also lowered the modulus by about 68% compared to the control. It also was found that a 5% isosorbide substitution retarded sorbitol re-crystallization over time, which is a major disadvantage of a sorbitol-containing TPS. At a 15% isosorbide substitution (Example 5), the modulus dropped further to a point where sample deformation in the tensile tester grips prevented further testing.

The isosorbide-plasticized TPS of Example 4 also exhibited an improved color over the TPS of Comparative Example 3. An isosorbide-plasticized TPS further demonstrated a reduced tendency of the plasticizer to migrate from the TPS, which is a major disadvantage of other plasticizers, like glycerol.

The data provided by the examples show that due to plasticization efficiency of isosorbide, the total plasticizer content of a TPS can be significantly reduced to effect cost savings and alleviate the disadvantages associated with current plasticizers in a range of TPS applications like extensible fibers, extruded films, and molded parts.

STEM studies of an isosorbide-containing TPS showed markedly different morphologies compared to a sorbitol-containing TPS. An isosorbide-containing TPS has a very homogenous matrix having a diffuse interface with the starch granules. For a sorbitol-containing TPS, the matrix is less homogeneous and the presence of phase separation and rod-like domains extending into the starch granules was observed. It is hypothesized, but not relied upon, that the differences in morphology primarily is due to sorbitol, which is known to crystallize and diffuse over time. Prior SEM images of TPSs have shown precipitation of ‘whisker’-like sorbitol crystals on the TPS pellet surface.

In a series of tests, blends containing polypropylene (PP)/starch/glycerol/isosorbide or sorbitol were prepared. It was found that dry blending granulated isosorbide with the other components and feeding the dry blend directly into the extruder led to feeding problems due to the low melting point of the isosorbide. To overcome this problem, isosorbide first was dissolved in glycerol and pumped into the extruder via a liquid side feeder. This technique allowed precise control over the loading levels.

A series of blends containing about 48% starch, about 22% PP, about 17% to about 22% glycerol, and about 9.5% to about 5% isosorbide by weight (maintaining a total plasticizer content (glycerol+isosorbide) of about 27 wt %) were compounded and pelletized. The morphology of these pellets then was compared to a similar blend containing about 48% starch, about 20% PP, about 10% glycerol, and about 23% sorbitol as a control. The test was designed to determine the effect of substituting a portion of sorbitol with isosorbide as a co-plasticizer (together with glycerol) in a TPS.

The resulting TPSs were subjected to Transmission (TEM) and Scanning Transmission Electron Microscopy (STEM). In general STEM images reveal the spatial distribution of structural domains (microstructure) in a sample.

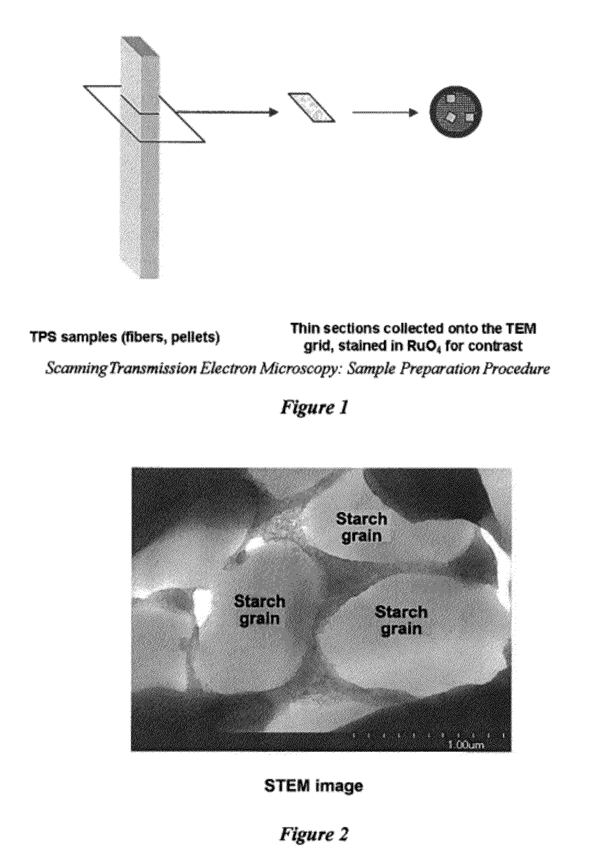

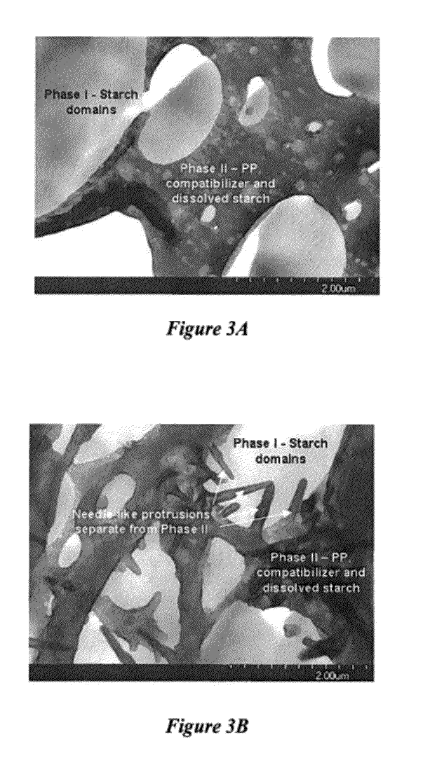

In order to examine the structure of a TPS by transmission microcopy, very fine, thin sections (50 nm and 60 nm) of the TPS pellets were prepared using a cryo-microtome preparation station. Slow cutting rates (0.2) and low temperatures (−120° C. to −140° C.) were used to cut a TPS into thin slices. Thin slices of sectioned material were transferred onto the TEM grids (600 hex mesh, copper). At least 4 grids (per each cutting direction) were prepared for each sample and each grid contained an average of about 15 sections. The samples were maintained in a closed system to prevent condensation and moisture pickup while warming the sections to room temperature (70° F.). The samples were stained in ruthenium tetroxide (RuO₄) fumes for 3.5 hours. RuO₄ stains polypropylene well and also can stain some OH groups, hut starch typically does not pick up the RuO₄ stain well. Such preferential staining allows identification of various components of the TPS blend. FIG. 1 schematically shows a sample preparation technique for typical STEM micrograph of a TPS structure. As demonstrated in the STEM image in FIG. 2, starch particles incorporated in a continuous matrix can be identified.

In addition to RuO₄ staining, a separate set of samples was exposed to osmium tetroxide (OsO₄) to selectively target the hydroxy (OH) groups of isosorbide and glycerol. All of the samples were imaged with 30 KV electron beam using Hitachi S-5200 field emission STEM. Additionally, some samples were analyzed using FEI C-120 TEM (bright field and selected area electron diffraction modes) to evaluate their structural details for local order.

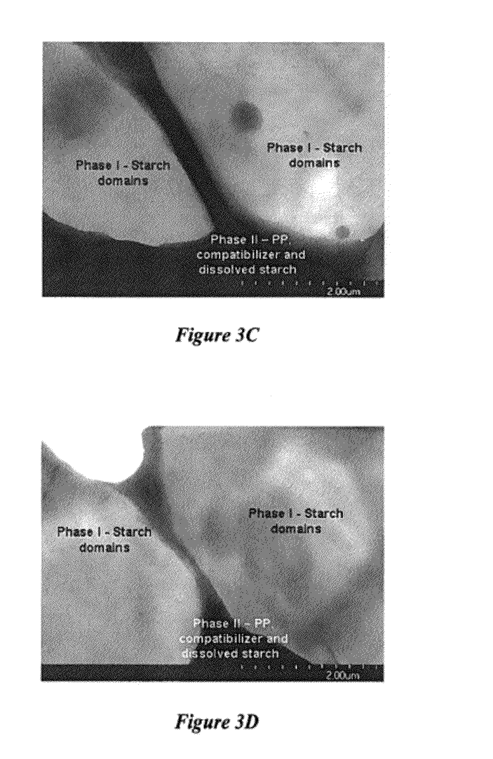

Based on the blending and structural study experiments, it was found that isosorbide has a strong effect on the stability of the matrix phase of the TPS/PP blend. Specifically, isosorbide-plasticized TPS-polymer blends show a very homogenous matrix with a diffuse interface with the starch granules. For sorbitol-plasticized TPS blends, the matrix is less homogeneous, and the presence of phase separation and rod-like domains was observed. FIGS. 3a-d show the different features between the isosorbide-plasticized blends and the sorbitol-plasticized blends.

In particular, the STEM images in FIG. 3 compare a sorbitol-plasticized TPS to an isosorbide-plasticized TPS, each compounded with polypropylene (PP). FIGS. 3A and 3B are STEM images of a blend containing starch, about 20% PP, 10% glycerol, and 23% sorbitol, compounded at 25 lb/hr. FIGS. 3C and 3D are STEM images of a blend containing starch, about 21.9% PP, 17.5% glycerol, and 9.5% isosorbide, compounded at 20 lb/hr.

FIGS. 3A and 3B show that the starch phase I is easily distinguished from the polypropylene (PP) matrix phase (FIG. 3A). A sharp boundary exists between starch granules and the PP matrix. The PP matrix phase also contains multiple other phases, i.e., the smaller microdomains shown as small bright spots, in dark areas of the figure. FIG. 3B shows that regions within the sample contained high densities of needle-like protrusions forming within the PP matrix. Such sorbitol crystallization over time leads to separation and migration of sorbitol to the surface and embrittlement of the TPS/PP blend.

The STEM images of FIGS. 3C and 3D show that a diffuse boundary exists between the starch granules and the PP matrix. In addition, the PP matrix is much more homogeneous, as evidenced by the lack of phase separation domains between starch globules. FIG. 3D shows that no needle-like protrusions formed over time, thereby reducing or overcoming the embrittlement problem associated with a sorbitol-plasticized TPS.

The above experiments and examples show that substituting a low weight percent of isosorbide for a plasticizer in a TPS can provide substantial improvements in physical properties of a TPS/polymer blend, and particularly ductility. Such an improvement in physical properties and morphology can have a substantial impact on fiber, films, and molded parts prepared from a synthetic polymer containing a present isosorbide-plasticized TPS.

Overall, isosorbide was found to lower the stiffness of TPS/synthetic polymer blends and increase elongation to break at a very low addition levels, without crystallizing out of the blend, like sorbitol, or migrating out of the blend, like liquid plasticizers (e.g., glycerol). A key problem with blends of starch or starch derivatives (e.g., hydroxyethylated or hydroxylpropylated starch) with polyolefins (PE, PP), glycerol, and sorbitol is stability of the blends over time. Such blends also are very heterogeneous when examined under scanning transmission electron microscopy (STEM) and physical properties tend to change over time. Replacement of all or a portion of the sorbitol with isosorbide provides a TPS that yields a much more homogenous and stable TPS/synthetic polymer blend.

1. A plasticized starch comprising:
(a) a starch or a starch derivative; and
(b) isosorbide, isomannide, isoidide, or a mixture thereof.

2. The plasticized starch of claim 1 wherein the starch is a natural starch.

3. The plasticized starch of claim 1 wherein the starch derivative is selected from the group consisting of starch, hydroxyethyl starch, hydroxypropyl starch, carboxymethylated starch, starch phosphate, starch acetate, a cationic starch, (2-hydroxy-3-trimethyl(ammoniumpropyl) starch chloride, a starch modified by acid, base, or enzyme hydrolysis, a starch modified by oxidation, and mixtures thereof.

4. The plasticized starch of claim 1 wherein component (b) comprises isosorbide.

5. The plasticized starch of claim 1 wherein component (b) is present in the plasticized starch in an amount of about 5% to about 45%, by weight of the plasticized starch.

6. The plasticized starch of claim 1 wherein the plasticized starch further comprises a second plasticizing agent.

7. The plasticized starch of claim 6 wherein a total amount of component (b) and second plasticizing agent in the plasticizing starch is about 5% to about 50%, by weight of the plasticized starch.

8. The plasticized starch of claim 7 wherein component (b) is present in an amount of about 5% to about 90% by weight of the total amount of component (b) and the second plasticizing agent.

9. The plasticized starch of claim 6 wherein the second plasticizing agent is selected from the group consisting of glycerol, ethylene glycol, propylene glycol, ethylene diglycol, propylene diglycol, ethylene triglycol, propylene triglycol, polyethylene glycol, polypropylene glycol, 1,2-propanediol, 1,3-propanediol, 1,2-butanediol, 1,3-butanediol, 1,4-butanediol, 1,5-pentanediol, 1,6-hexanediol, 1,5-hexanediol, 1,2,6-hexanetriol, 1,3,5-hexanetriol, neopentyl glycol, trimethylolpropane, pentaerythritol, sorbitol, glycerol ethoxylate, tridecyl adipate, isodecyl benzoate, tributyl citrate, tributyl phosphate, dimethyl sebacate, urea, pentaerythritol ethoxylate, sorbitol acetate, pentaerythritol acetate, ethylenebisformamide, a low molecular weight sugar, sorbitol diacetate, sorbitol monoethoxylate, sorbitol diethoxylate, sorbitol hexaethoxylate, sorbitol dipropoxylate, aminosorbitol, trihydroxymethylaminomethane, glucose/PEG, a reaction product of ethylene oxide with glucose, trimethylolpropane monoethoxylate, mannitol monoacetate, mannitol monoethoxylate, butyl glucoside, glucose monoethoxylate, α-methyl glucoside, the sodium salt of carboxymethylsorbitol, sodium lactate, polyglycerol monoethoxylate, erythriol, arabitol, adonitol, xylitol, mannitol, iditol, galactitol, allitol, malitol, polyhydric alcohols generally, esters of glycerin, formaide, N-methylformamide, DMSO, a monoglyceride, a diglyceride, an alkylamide, a polyol, a polyvinyl alcohol having 3 to 20 repeating units, a polyglycerol having 2 to 10 repeating units, derivatives of the foregoing, and mixtures thereof.

10. A blend comprising:
(a) a plasticized starch of claim 1 or claim 6; and
(b) a synthetic polymer.

11. The blend of claim 10 wherein the synthetic polymer is present in the blend in an amount of about 1% to about 90%, by weight of the blend.

12. The blend of claim 10 wherein the synthetic polymer is selected from the group consisting of polyethylene, polypropylene, polyisobutylene, a vinyl polymer, poly(vinyl chloride), poly(vinyl acetate), a poly(vinyl carbazole), a polystyrene, a substantially water-insoluble polyacrylate, a substantially water-insoluble, a polymethacrylate, a poly(acrylic acid)ester, a poly(methacrylic acid)ester, a polyacetal, a polyamide, a nylon6, nylon-6,6, an aliphatic or aromatic polyamide, a polyester, poly(ethylene terephthalate), poly(butylene terephthalate), a polyarylether, a polyurethane, a polycarbonate, a polyimide, a substantially water-insoluble or crystallizable poly(alkylene oxide), a poly(ethylene oxide), a poly(propylene oxide), a polyester, a polylactide, a polylactone, a poly(epsilon-caprolactone), a copolymer of epsilon-caprolactone with an isocyanate, a bacterial poly(hydroxyalkanoate), poly(hydroxybutyrate-3-hydroxyvalerate), a polylactide, poly(lactic acid), poly(glycolic acid), a substantially water-insoluble thermoplastic α-olefin copolymer, an alkylene/vinyl ester-copolymer, an ethylene/vinyl acetate-copolymer, an ethylene/vinyl alcohol-copolymer, an alkylene/acrylate or a methacrylate-copolymer, an ethylene/acrylic acid-copolymer, an ethylene/ethyl acrylate-copolymer, an ethylene/maleic anhydride copolymer, a propylene/maleic anhydride copolymer, an ethylene/methyl acrylate-copolymer, a styrenic copolymer, an α-olefin/styrene-copolymer, a hydrogenated or non-hydrogenated styrene/ethylene-butylene/styrene copolymer, a styrene/ethylene-butadiene copolymer, a styrene acrylonitrile copolymer, an acrylonitrile/butadiene/styrene copolymer, an acrylic acid ester/acrylonitrile copolymer, an acrylamide/acrylonitrile copolymer, a block copolymer of an amide-ester, a block copolymer of a urethane-ether, a block copolymer of urethane-ester, an epoxy, polyurethane, or polyester thermoset resin, and mixtures thereof.
